(19) United States
(12) Patent Application Publication
(10) Pub. No.: US 2015/0188107 A1
(43) Pub. Date: Jul. 2, 2015

(54) NON-AQUEOUS ELECTROLYTE SECONDARY BATTERY

(71) Applicant: SANYO Electric Co., Ltd., Moriguchi-shi, Osaka (JP)

(72) Inventors: Noriko Sugii, Tokushima (JP); Masato Iwanaga, Tokushima (JP)

(73) Assignee: SANYO Electric Co., Ltd., Moriguchi-shi, Osaka (JP)

(21) Appl. No.: 14/411,040

(22) PCT Filed: Sep. 18, 2013
(86) PCT No.: PCT/JP2013/005506

§ 371 Date: Dec. 23, 2014

(30) Foreign Application Priority Data
Sep. 27, 2012 (JP) 2012-214408

(51) Int. Cl. H01M 2/16; H01M 10/0525; H01M 4/583

(52) U.S. Cl. CPC H01M 2/1686; H01M 4/583; H01M 10/0525; H01M 2220/30; H01M 2220/20

(57) ABSTRACT

A non-aqueous electrolyte secondary battery comprising a positive electrode plate, a negative electrode plate, a separator, and a non-aqueous electrolyte, and the negative electrode active material is a mixture of a graphite material, and silicon or a silicon compound, and the separator is a polyolefin microporous film, which contains polyethylene as an essential component and is formed of a multilayer film having at least two layers, and the separator contains inorganic particles at least in the surface layer on the side facing the negative electrode plate.

### TECHNICAL FIELD

The present invention is related to a non-aqueous electrolyte secondary battery which has excellent cycle characteristics and a large initial capacity, in which a mixture of silicon or a silicon compound with a graphite material is used as a negative electrode active material as a means for increasing a capacity of the non-aqueous electrolyte secondary battery.

### BACKGROUND ART

In recent years, mobile or portable electronic equipment such as mobile telephones (including smartphones), portable computers, PDAs, and portable music players, have been widely used. According to requirements of high functionality, downsizing, and weight-saving in such electronic equipment, secondary batteries with a high capacity as its drive power source are required. Further, regulations on emissions of gases causing global warming such as carbon dioxide have been strengthened against a background of growing environmental protection movements in recent years. In the car industry, electric vehicles (EVs) and hybrid electric vehicles (HEVs) have been actively developed in place of automobiles using fossil fuels such as gasoline, diesel oil, and natural gas.

Nickel-hydrogen secondary batteries or lithium ion secondary batteries have been generally used as drive power sources for the EVs and HEVs. In recent years, non-aqueous electrolyte secondary batteries such as the lithium ion secondary batteries have been widely used because such batteries can be lightweight and have a high capacity. Furthermore, in stationary storage battery systems for suppressing output fluctuation of solar power generation and wind power generation, and for a peak shift of grid power that utilizes the power during the daytime while saving the power during the nighttime.

As the negative electrode active material used in the non-aqueous electrolyte secondary batteries, carbonaceous materials such as graphite, amorphous carbon and the like are widely used because of their excellent properties of high safety by inhibiting the growth of dendrites, superior initial efficiency, satisfactory potential flatness and high density while having a discharge potential comparable to that of a lithium metal or lithium alloy. However, in the negative electrode active material consisting of the carbonaceous materials, lithium is inserted only up to the composition of LiC₆, so its theoretical capacity is at most 372 mAh/g, causing an obstruction in increasing a battery capacity.

Therefore, there has been developed a non-aqueous electrolyte secondary battery using silicon forming an alloy with lithium, a silicon alloy, or silicon oxide as a negative electrode active material with a high capacity per unit mass and per unit volume. In this case, for example, silicon can insert lithium up to the composition of Li₄₄Si, exhibiting its theoretical capacity of 4200 mAh/g. Thus, its expected capacity is much higher than that of the carbonaceous materials used as the negative electrode active material. However, when there is used silicon, a silicon alloy, or a silicon oxide as a negative electrode active material, since large expansion and contraction occur as the charge and discharge cycle proceeds, they are susceptible to pulverization and falling off a conductive network. As a result, a non-aqueous electrolyte battery has a problem that charge and discharge cycle characteristics may be deteriorated. To solve the problem, various improvements have been developed.

For example, the below patent literature 1 describes the following non-aqueous electrolyte secondary battery. Its negative electrode comprises a negative electrode active material mixture layer containing a graphite and a material which includes silicon and oxygen (the element ratio x of silicon to oxygen is 0.5×1.5) as a constituent element. When the total of the graphite and the material including the silicon and the oxygen as the constituent element is taken as 100% by mass, the ratio of the material including the silicon and the oxygen is 3 to 20% by mass.

Further, the below patent literature 2 describes the following lithium secondary battery. In the lithium secondary battery using a negative electrode active material of a mixture of a graphite material, and silicon or a silicon compound, a separator is coated with inorganic particles for the purpose of obtaining the lithium secondary battery having excellent cycle characteristics.

### CITATION LIST

### Patent Literature

Patent Literature 1: Japanese Laid-Open Patent Publication No. 2010-212228
Patent Literature 2: Japanese Laid-Open Patent Publication No. 2011-233245

### SUMMARY OF THE INVENTION

As described in the above patent literature 1, the non-aqueous electrolyte secondary battery uses the silicon oxide having a high capacity and the large volume variation in charging and discharging, and it suppresses the deterioration of the battery characteristics from the large volume variation. It has the excellent battery characteristics without greatly changing the configuration of the conventional non-aqueous electrolyte secondary battery. Also, as described in the above patent literature 2, the lithium secondary battery, namely the non-aqueous electrolyte secondary battery, exhibits a certain improvement effect in the cycle characteristics by using the separator having the specific configuration.

By the way, in silicon, a silicon compound of SiOₓ, or the like, the volume variation in charging and discharging is about two times larger than that of a graphite material. When a negative electrode active material contains the silicon, the silicon compound of SiOₓ, or the like, the large volume variation of the negative electrode active material at the first charging results in the occurrence of a phenomenon in which the non-aqueous electrolyte is expelled from a spiral electrode assembly. In a case that the non-aqueous electrolyte is not held by the spiral electrode assembly, there is a problem that the cycle characteristics are decreased. However, the above patent literatures 1 and 2 do not describe the cycle characteristics in the case of using a mixture of a graphite material, and the silicon, the silicon compound of SiOₓ, or the like as the negative electrode active material.

The present disclosure is developed for solving the aforementioned problems, and aims to provide a non-aqueous electrolyte secondary battery which exhibits excellent cycle characteristics and also has a large initial capacity in the case of using the mixture of the graphite material, and silicon or the silicon compound as the negative electrode active material.

In order to accomplish the above object, a non-aqueous electrolyte secondary battery of the present disclosure comprises: a positive electrode plate being provided with a positive electrode mixture layer containing a positive electrode active material capable of absorbing and desorbing lithium ions, a negative electrode plate being provided with a negative electrode mixture layer containing a negative electrode active material capable of absorbing and desorbing lithium ions, a separator, and a non-aqueous electrolyte, wherein: the negative electrode active material is a mixture of a graphite material, and silicon or a silicon compound; and the separator is a polyolefin microporous film, which contains polyethylene as an essential component and is formed of a multilayer film having at least two layers; and the separator contains inorganic particles at least in a surface layer on the side facing the negative electrode plate.

In the non-aqueous electrolyte secondary battery of the present disclosure, the negative electrode active material includes the graphite material, and silicon or the silicon compound. Such silicon or the silicon compound has a larger theoretical capacity than that of the graphite material. Therefore, the non-aqueous electrolyte secondary battery of the present disclosure enables the battery capacity to be larger than that of a non-aqueous electrolyte secondary battery having a negative electrode active material consisting of only graphite.

In addition, the separator used in the non-aqueous electrolyte secondary battery of the present disclosure is the polyolefin microporous film, which contains polyethylene as an essential component and is formed of the multilayer film having at least two layers, and the separator contains inorganic particles at least in a surface layer on the side facing the negative electrode plate. When the separator contains polyethylene as an essential component, permeability of lithium ions and a function of a shutdown at the time of temperature increase become excellent. Further, when the separator contains inorganic particles at least in a surface layer on the side facing the negative electrode plate, a liquid holding property of the separator is improved, making it possible to hold the non-aqueous electrolyte within the separator, even though the negative electrode active material expands in charging.

Also, since stiffness of the separator is enhanced by disposing the inorganic particles-containing layer at least in the surface layer on the side facing the negative electrode plate, the volume variation of the negative electrode active material at the time of the repeated expansion and contraction in charging and discharging is suppressed, resulting in the remarkable effect of holding the non-aqueous electrolyte within the separator. Thus, the non-aqueous electrolyte secondary battery of the present disclosure, by the combined above electrolyte holding effect and volume variation suppression effect, can provide a non-aqueous electrolyte secondary battery having a large capacity and excellent cycle characteristics, even when the negative electrode active material contains the graphite material, and silicon or the silicon compound.

Here, in the same manner as the non-aqueous electrolyte secondary disclosed in the above patent literature 2, when the separator coated with the inorganic particles is used, the coating manner includes the addition of a dispersant, a thickener, and a binder. The addition of them inhibits the charging and discharging performance. Therefore, the non-aqueous electrolyte secondary battery of the present disclosure has more excellent cycle characteristics than those of the non-aqueous electrolyte secondary disclosed in the above patent literature 2.

Moreover, in the non-aqueous electrolyte secondary battery of the present disclosure, it is preferable that the content of the inorganic particles at least in the surface layer on the side facing the negative electrode plate is 1% by mass or more and 40% by mass or less.

Here, when the content of the inorganic particles at least in the surface layer on the side facing the negative electrode plate is less than 1%, there is few effect of adding the inorganic particles. Here, when the content of the inorganic particles at least in the surface layer on the side facing the negative electrode plate is more than 40%, the mechanical strength of the separator is adversely affected and it is difficult to form a film. Therefore, that is not desirable. More preferably, the content of the inorganic particles in the surface layer on the side facing the negative electrode plate is 2.5% by mass or more and 40% by mass or less.

Moreover, in the non-aqueous electrolyte secondary battery of the present disclosure, it is preferable that the inorganic particles include one or more kinds of oxides and nitrides of at least one element selected from the group consisting of silicon, aluminum, and titanium. Since these inorganic particles have the electric insulation, the stability in the non-aqueous electrolyte, and the high hardness, the above effects are obtained.

Moreover, in the non-aqueous electrolyte secondary battery of the present disclosure, it is preferable that the content of the silicon or the silicon compound in the negative electrode active material is 1% by mass or more and 20% by mass or less. Containing the silicon or the silicon compound in the negative electrode active material enables a high capacity.

Moreover, in the non-aqueous electrolyte secondary battery of the present disclosure, it is preferable that the silicon compound is silicon oxide expressed by SiOₓ (0.5≦x<1.6). When the silicon oxide expressed by SiOₓ (0.5≦x<1.6) is used as one part of the negative electrode active material in combination with the graphite, a large capacity and excellent cycle characteristics are obtained.

Here, as the positive electrode active material used in the non-aqueous electrolyte secondary battery of the present disclosure, the conventional compound that can reversibly adsorb and desorb lithium ions may be used. As the compound that can reversibly adsorb and desorb positive lithium ions, for example, lithium transition-metal composite oxides expressed by LiMO₂ (where M is at least one of Co, Ni, and Mn), namely LiCoO₂, LiNiO₂, LiNi_{y}Co_{1-y}O₂ (y=0.01 to 0.99), LiMnO₂, LiCoₓNn_{y}Ni_{z}O₂ (x+y+z=1), LiMn₂O₄, LiFePO₄, and the like may be used singly or as a mixture of two or more of them. Further, lithium cobalt composite oxides with dissimilar metal element such as zirconium, magnesium, and aluminum added thereto may be used as well.

Here, examples of the non-aqueous solvent used in the non-aqueous electrolyte secondary battery of the present disclosure include: cyclic carbonates such as ethylene carbonate (EC), propylene carbonate (PC), and butylene carbonate (BC); fluorinated cyclic carbonates; cyclic carboxylic esters such as γ-butyrolactone (γ-BL) and γ-valerolactone (γ-VL); chain carbonates such as dimethyl carbonate (DMC), ethyl methyl carbonate (EMC), diethyl carbonate (DEC), methylpropyl carbonate (MPC), and dibutyl carbonate (DBC); fluorinated chain carbonates; chain carboxylic esters such as methyl pivalate, ethyl pivalate, methyl isobutyrate, and methyl propionate; amide compounds such as N,N′-dimethylformamide and N-methyl oxazolidinone; sulfur compounds such as sulfolane; and ambient-temperature molten salts such as tetrafluoroboric acid and 1-ethyl-3-methylimidazolium. Two or more of them may be used in combination.

Here, as electrolyte salts in the non-aqueous solvent used in the non-aqueous electrolyte secondary battery of the present disclosure, lithium salts commonly used as the electrolyte salt in a non-aqueous electrolyte secondary battery may be used. Examples of such a lithium salt include LiPF₆ (Lithium hexafluorophosphate), LiBF₄, LiCF₃SO₃, LiN (CF₃SO₂)₂, LiN (C₂F₅SO₂)₂, LiN (CF₃SO₂) (C₄F₉SO₂), LiC(CF₃SO₂)₃, LiC (C₂F₅SO₂),₃, LiAsF₆, LiCIO₄, U₂B₁₉O₁₀, U₂B₁₂O₁₂ and mixtures of them. Among them, especially, LiPF₆ is preferable. The amount of electrolyte salt dissolved in the non-aqueous solvent is preferably from 0.5 to 2.0 mol/L.

To the non-aqueous electrolyte of the non-aqueous electrolyte secondary battery of the present disclosure, the following compounds for stabilizing the electrodes may be further added: vinylene carbonate (VC), vinyl ethyl carbonate (VEC), propane sultone (PS), succinic anhydride (SUCAH), maleic anhydride (MAAH), glycolic anhydride, ethylene sulfite (ES), divinyl sulfone (VS), vinyl acetate (VA), vinyl pivalate (VP), catechol carbonate, and biphenyl (BP). Two or more of these compounds can also be used in appropriate combination.

### BRIEF DESCRIPTION OF DRAWINGS

FIG. 1 is a partially exploded perspective view of a prismatic non-aqueous electrolyte battery which is common to each of examples and comparative examples.

### DESCRIPTION OF EMBODIMENTS

Embodiments for carrying out the invention will now be described in detail. It is to be understood, however, that the following embodiments are intended for embodying the technical concepts of the invention, and the invention can be applied to various modifications without departing from the technical concepts set forth in the claims.

A non-aqueous electrolyte secondary battery related to examples and comparative examples is explained in detail in the following. First, the common configuration in each of the examples and the comparative examples is explained.

### [Preparation of Positive Electrode Plate]

For the positive electrode active material, a mixture of dissimilar element-added lithium cobalt oxide and cobalt-containing layered lithium-nickel-manganese oxide was used. The dissimilar element-added lithium cobalt oxide was prepared as follows. As the starting materials, lithium carbonate (Li₂CO₃) was used for the lithium source, while, for the cobalt sources, zirconium- and magnesium-added tricobalt (Co₃O₄) was used that was obtained by coprecipitation, followed by thermal decomposition, from an aqueous solution with 0.2 mol % of zirconium and 0.5 mol % of magnesium, relative to the cobalt, added as dissimilar elements during synthesis of cobalt carbonate. Thereafter, they were weighed out in a predetermined amount and mixed, then calcined for 24 hours at 850° C. in an air atmosphere to obtain zirconium- and magnesium-added lithium cobalt oxide. This was pulverized in a mortar to an average particle size of 14 μm, producing the positive electrode active material A.

The cobalt-containing layered lithium-nickel-manganese oxide was prepared as follows. As the starting materials, lithium carbonate (Li₂CO₃) was used for the lithium source, while for the transition metal source, a coprecipitated hydroxide expressed by Ni_{0.33}Mn_{0.33}Co_{0.34}(OH)₂ was used. They were weighed out in a predetermined amount and mixed together, then calcined for 20 hours at 1000° C. in an air atmosphere to obtain cobalt-containing lithium-nickel-manganese oxide expressed by LiMn_{0.33}Ni_{0.33}Co_{0.34}O₂. This was pulverized to an average particle size of 5 μm, producing the positive electrode active material B.

The above obtained positive electrode active material A and B were mixed in the ratio of 7:3 by mass, and then 94 parts by mass of the positive electrode active materials, 3 parts by mass of carbon powder as a conductive agent, and 3 parts by mass of polyvinylidene fluoride (PVdF) powder as a binder were mixed. The resultant mixture was dispersed in N-methyl-2-pyrrolidone (NMP) to make a positive electrode mixture slurry. This positive electrode mixture slurry was coated on both surfaces of a 15 μm (=micrometer) thick positive electrode collector made of aluminum by the doctor blade method and dried, to form positive electrode mixture layers on both surfaces of the positive electrode collector. Then, the resultant item was compressed with a roll press to prepare the positive electrode plate having a length of 36.5 mm in a short side.

### [Preparation of Negative Electrode Plate]

Particles of the composition of SiOₓ (x=1) were pulverized and classified to adjust the particle size. After that, the surfaces of the particles were coated with carbon at 1000° C. (degree celsius) under an argon atmosphere by the CVD method. Then, by pulverizing and classifying the particles, silicon oxide expressed by SiOₓ was prepared. Here, conventional various methods can be used as a method of coating SiOₓ particles with carbon. In addition, the treatment of coating SiOₓ particles with carbon can be omitted.

Graphite and the above prepared silicon oxide expressed by SiOₓ (x=1) were mixed in the ratio of 96:4 by mass to prepare the negative electrode active material. Next, this negative electrode active material and styrene-butadiene rubber (SBR) (ratio of styrene:butadiene=1:1) as a binder were mixed and despersed in NMP. And then, carboxymethylcellulose (CMC) as a thickener was added to make a negative electrode active material mixture slurry. Here, the ratio by mass in a dried state of the negative electrode active material mixture slurry was adjusted to be the negative electrode active material:SBR:CMC=100:3:2. This negative electrode mixture slurry was coated on both surfaces of an 8 μm thick negative electrode collector made of copper by the doctor blade method and dried to form the negative electrode mixture layers on both surfaces of the negative electrode collector. Then, the resultant item was compressed with a roll press to prepare the negative electrode plate having a length of 37.5 mm in a short side.

### [Preparation of Non-Aqueous Electrolyte]

Ethylene carbonate (EC), methyl ethyl carbonate (MEC), and diethyl carbonate (DEC) were mixed in the proportion of 20:30:50 by volume to prepare a non-aqueous solvent. LiPF₆ as an electrolyte salt was dissolved in the solvent to be 1 mol/L.

### [Preparation of Separator]

So as to configure a three-layered separator or a two-layered separator in which the layer containing inorganic particles were disposed in each of the both surfaces or in the one surface respectively, the materials mentioned below of each layer were mixed together and were formed in a sheet shape by a coextrusion method while kneading and thermally melting them. After that, the resulting sheets were extended to prepare the separators used in Examples 1 to 10 and Comparative Example 1 to 4. Here, the layers containing the inorganic particles were prepared by mixing a polyethylene-containing material, an inorganic material (silica), and a plasticizer. The other layers were prepared by mixing the polyethylene-containing material and the plasticizer. Further, the separators of Comparative Examples 1 and 4 containing no inorganic particles were prepared as follows. The polyethylene-containing material and the plasticizer were extruded while kneading and thermally melting them, and were formed in a sheet shape. After that, the plasticizer was extracted, and the resulting sheets were dried and extended. Here, the reason why the separator contains polyethylene as an essential component is to provide superior permeability of lithium ions and a shutdown property which makes it possible to reduce the pore diameter of the separator by melting it at the time of the temperature increase in the battery.

### [Preparation of Battery]

The positive electrode plate and the negative electrode plate, each prepared as described above, were wound with the separator interposed therebetween in a state of being insulated from each other. And then, a tape made of polypropylene was stuck on the outermost periphery of the winding body to prepare the cylindrical spiral electrode assembly, and pressed it to prepare the flat spiral electrode assembly.

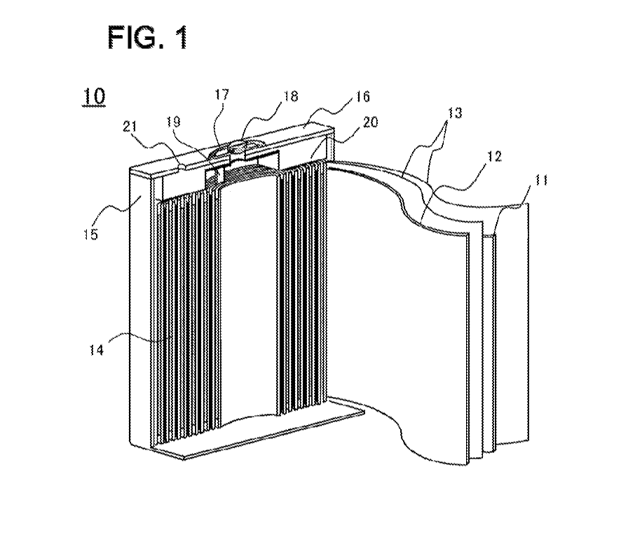

Next, the configuration of the prismatic non-aqueous electrolyte battery which is common to each of the examples and the comparative examples is explained by using FIG. 1. Here, FIG. 1 is a partially exploded perspective view of the prismatic non-aqueous electrolyte battery which is common to each of examples and comparative examples.

This prismatic non-aqueous electrolyte secondary battery 10 included the flat spiral electrode assembly 14 in which the positive electrode plate 11 and the negative electrode plate 12 were wound through the separator 13 therebetween, a prismatic battery case 15, and a sealing plate 16 which seals this battery case 15. The spiral electrode assembly 14 was stored in the inner space sealed by the battery case 15 and the sealing plate 16. The positive electrode plate 11 was provided with the positive electrode mixture layer containing the positive electrode active material capable of absorbing and desorbing the lithium ions. Similarly, the negative electrode plate 12 was provided with the negative electrode mixture layer containing the negative electrode active material capable of absorbing and desorbing the lithium ions.

In the spiral electrode assembly 14, for example, the positive electrode plate 11 was wound such that the positive electrode plate 11 was exposed at its outermost periphery. The exposed outermost positive electrode plate 11 directly contacted the inner surface of the battery case 15, which also had a function of the positive electrode terminal, and was electrically connected to the battery case 15. In addition, the negative electrode plate 12 was electrically connected to a negative electrode terminal 18 fixed at the center of the sealing plate via a negative electrode tab 19 with an insulating member 17 interposed therebetween.

An insulating spacer 20 was disposed between the top portion of the spiral electrode assembly 14 and the sealing plate 16. Therefore, the battery case 15 electrically connected to the positive electrode plate 11 and the negative electrode plate 12 were insulated from each other, and a short circuit between the battery case 15 and the negative electrode plate 12 was prevented. Here, the disposition of the positive electrode plate 11 and the negative electrode plate 12 can be changed for each other. In the prismatic non-aqueous electrolyte secondary battery 10, the spiral electrode assembly 14 was inserted into the battery case 15, and the sealing plate 16 was welded by laser to the opening portion of the battery case 15. After that, the non-aqueous electrolyte was injected through an electrolyte injection aperture 21 of the sealing plate 16, and the electrolyte injection aperture 21 was sealed to prepare the prismatic non-aqueous electrolyte secondary battery 10.

Here, a design capacity of the prepared prismatic non-aqueous electrolyte secondary battery was 800 mAh. Further, in Examples 1 to 10 and Comparative Examples 1 to 4, the content (% by mass) of the silicon oxide expressed by SiOₓ (x=1) in the negative electrode active material, and the content (% by mass) of the inorganic particles in the separator are shown in Table 1.

### [Measurement of Battery Characteristics]

### (Cycle Characteristics)

At 25° C. (degree Celsius), after the batteries were charged with a constant current of 1 It=800 mA and the battery voltage reached 4.4 V, the batteries were charged with a constant voltage of 4.4 V until a charging current reached 20 mA. After that, the batteries were discharged with a constant current of 1 It=800 mA until 3.0 V of the batteries, and the discharge capacity of the first cycle was measured as an initial capacity. Such charge and discharge cycle was taken as the first cycle. The charge and discharge cycle on the same condition as that of the first cycle was repeated 300 times, and the discharge capacity at the 300th cycle was measured. And then, by the following calculation formula, a remaining capacity rate after cycles was calculated. The results of the initial capacity and the remaining capacity rate after cycles are shown in Table 1.

The remaining capacity rate after cycles=(the discharge capacity at the 300th cycle/the initial capacity).

TABLE 1

| | | content of inorganic | | remaning capacity | |
|---|---|---|---|---|---|
| | content of silicon | partides(% by mass) | | rate after cycles | initial capacity |
| | oxide (% by mass) | nega. elec. side | posi. elec. side | (%) | (mAh) |
| Example 1 | 0.5 | 7 | 7 | 89 | 820 |
| Example 2 | 1 | 7 | 7 | 86 | 829 |
| Example 3 | 3.5 | 1 | 1 | 80 | 834 |
| Example 4 | 3.5 | 2.5 | 2.5 | 84 | 835 |
| Example 5 | 3.5 | 7 | 7 | 85 | 834 |
| Example 6 | 3.5 | 20 | 20 | 87 | 835 |
| Example 7 | 20 | 7 | 7 | 82 | 840 |
| Example 8 | 25 | 7 | 7 | 79 | 889 |
| Com. Ex. 1 | 3.5 | 0 | 0 | 73 | 831 |
| Com. Ex. 2 | 0 | 7 | 7 | 88 | 808 |
| Example 9 | 3.5 | 40 | 0 | 88 | 836 |
| Example 10 | 3.5 | 2.5 | 0 | 82 | 836 |
| Com. Ex. 3 | 3.5 | 0 | 40 | 72 | 833 |
| Com. Ex. 4 | 0 | 0 | 0 | 76 | 811 |

From the results shown in Table 1, the following is understood. Namely, from the results of Example 1, Example 2, Example 5, Example 8, and Comparative Example 2 each having a content of the inorganic particles of 7% by mass at both negative and positive electrode plate sides of the separator, containing the silicon oxide expressed by SiOₓ (x=1) in the negative electrode active material enables a high capacity, and more preferably its content is 1% by mass or more and 20% by mass or less.

In addition, from the results of Examples 3 to 6 each having a content of the silicon oxide expressed by SiOₓ (x=1) of 3.5% by mass in the negative electrode active material, when the inorganic particles are contained at both negative and positive electrode plate sides of the separator, it is understood that the excellent cycle characteristics and initial capacity can be obtained. Similarly, from the results of Examples 9 and 10, also when the inorganic particles are contained only at the negative electrode plate side of the separator, it is understood that the excellent cycle characteristics and initial capacity can be obtained. Similarly, the results of Comparative Example 3 show that, when the inorganic particles are contained only at the positive electrode plate side of the separator, the cycle characteristics are deteriorated though an excellent initial capacity is obtained. Here, the results of Comparative Example 4, in which the silicon oxide expressed by SiOₓ (x=1) in the negative electrode active material are not contained and the inorganic particles are not contained at any one of the negative and positive electrode plate sides of the separator, show that both the initial capacity and the cycle characteristics are deteriorated.

Therefore, evidently, it is necessary that the separator contains inorganic particles at least in a surface layer on the side facing the negative electrode plate when the silicon oxide expressed by SiOₓ (x=1) material is contained in the negative electrode active.

In addition, the results of Examples 3 to 6, 9, and 10 each having a content of the silicon oxide expressed by SiOₓ (x=1) of 3.5% by mass in the negative electrode active material, show that, when the content of the inorganic particles at least in the surface layer on the side facing the negative electrode plate in the surface layer is 1% by mass or more and 40% by mass or less, the excellent cycle characteristics and initial capacity are obtained. Moreover, when the content of the inorganic particles at least in the surface layer on the side facing the negative electrode plate in the surface layer is 2.5% by mass or more and 40% by mass or less, it is clear that the more excellent cycle characteristics and initial capacity can be obtained. Here, when the content of the inorganic particles at least in the surface layer on the side facing the negative electrode plate in the surface layer is more than 40%, the mechanical strength of the separator is adversely affected and it is difficult to form a film.

Here, though the above Examples 1 to 10 show the examples using the silicon oxide expressed by SiOₓ (x=1), silicon oxide expressed by SiOₓ (0.5≦x<1.6) can be similarly available.

In addition, the above Examples 1 to 10 show the examples using the silica as an inorganic compound of the inorganic particles contained at least in the surface layer on the side facing the negative electrode plate. However, as the inorganic compound, anything which has electric insulation, stability that is hardly to undergo a reaction in the non-aqueous electrolyte, and high hardness can be selected and used. Preferably, examples of the inorganic compound include one or more kinds of oxides and nitrides of at least one element selected from the group consisting of silicon, aluminum, and titanium.

### Comparative Example 5

The above Examples 1 to 10 show examples using the separator which contains the inorganic particles at least in the surface layer on the side facing the negative electrode plate. As Comparative Example 5, in order to confirm the difference with the example in which the inorganic particles were coated on the surface of the separator, a non-aqueous electrolyte secondary battery was prepared in which the silica as an inorganic particle was coated on the both surfaces at the negative electrode-side and the positive electrode-side of the separator, together with the dispersion, the thickener, and the binder.

In the non-aqueous electrolyte secondary battery of Comparative Example 5, the content of the silicon oxide expressed by SiOₓ (x=1) in the negative electrode active material was 3.5% by mass, and the content of the inorganic particles in the coated layers formed on both surfaces at the negative and positive electrode plate sides were about 95% by mass relative to the each coated layer. Also, the other conditions are the same as the non-aqueous electrolyte secondary battery of Example 5. The cycle characteristics and initial capacity of Comparative Example 5 prepared in such a way are shown in Table 2 with the results of Example 5.

TABLE 2

| | | content of inorganic | | remaining capacity | |
|---|---|---|---|---|---|
| | content of silicon | particles (% by mass) | | rate after cycles | initial capacity |
| | oxide (% by mass) | nega. elec. side | posi. elec. side | (%) | (mAh) |
| Example 5 | 3.5 | 7 | 7 | 85 | 834 |

| | | | | |
|---|---|---|---|---|
| Com. Ex. 5 | 3.5 | separator having coated layers | 74 | 830 |
| | | mainly containing inorganic | | |
| | | particles | | |

The results of Table 2 reveals that, when the inorganic particles coat are coated on the surfaces of the separator as Comparative Example 5, the cycle characteristics are deteriorated though the initial capacity is the about same as the Example 5, compared with the case of Example 5. Since the inorganic particles were coated on the surface of the separator with the dispersant, the thickener, and the binder added, the addition of them causes the inhibition of the charging and performance, resulting in the deterioration of the cycle characteristics.

On the contrary to that, when the separator which contains the inorganic particles at least in the surface layer on the side facing the negative electrode plate is used like Example 5, there is probably no inhibition of the charging and discharging performance by addition of the dispersant, the thickener, and the binder. Therefore, in Example 5 compared with Comparative Example 5, the charging and discharging performance is improved, and the non-aqueous electrolyte secondary battery excellent in both the cycle characteristics and the initial capacity is obtained.

### REFERENCE MARKS IN THE DRAWINGS

10: non-aqueous electrolyte secondary battery
11: positive electrode plate
12: negative electrode plate
13: separator
14: spiral electrode assembly
15: battery case
16: sealing plate
17: insulating member
18: negative electrode terminal
19: negative electrode tab
20: insulating spacer
21: electrolyte injection aperture

1. A non-aqueous electrolyte secondary battery comprising:
a positive electrode plate being provided with a positive electrode mixture layer containing a positive electrode active material capable of absorbing and desorbing lithium ions;
a negative electrode plate being provided with a negative electrode mixture layer containing a negative electrode active material capable of absorbing and desorbing lithium ions;
a separator; and
a non-aqueous electrolyte,
wherein: the negative electrode active material is a mixture of a graphite material, and silicon or a silicon compound;
the separator is a polyolefin microporous film, which contains polyethylene as an essential component and is formed of a multilayer film having at least two layers; and
the separator contains inorganic particles at least in a surface layer on the side facing the negative electrode plate.

2. The non-aqueous electrolyte secondary battery according to claim 1,
wherein the content of the inorganic particles in the surface layer on the side facing the negative electrode plate is 2.5% by mass or more and 40% by mass or less.

3. The non-aqueous electrolyte secondary battery according to claim 1,
wherein the inorganic particles comprise one or more kinds of oxide and nitrides of at least one element selected from the group consisting of silicon, aluminum, and titanium.

4. The non-aqueous electrolyte secondary battery according to claim 1,
wherein the content of the silicon or the silicon compound to the mass of the negative electrode active material is 1% by mass or more and 20% by mass or less.

5. The non-aqueous electrolyte secondary battery according to claim 1,
wherein the silicon compound is a silicon oxide expressed by SiOₓ (0.5≦x<1.6).
